(19) United States
(12) Patent Application Publication
(10) Pub. No.: US 2020/0224611 A1
(43) Pub. Date: Jul. 16, 2020

(54) EVAPORATED FUEL TREATMENT APPARATUS

(71) Applicant: AISAN KOGYO KABUSHIKI KAISHA, Obu-shi (JP)

(72) Inventors: Yoshihiko HONDA, Obu-shi (JP); Masanobu SHINAGAWA, Nagoya-shi (JP); Takanori AKIYAMA, Nagoya-shi (JP)

(73) Assignee: AISAN KOGYO KABUSHIKI KAISHA, Obu-shi (JP)

(21) Appl. No.: 16/727,182

(22) Filed: Dec. 26, 2019

(30) Foreign Application Priority Data
Jan. 15, 2019 (JP) 2019-004386

(51) Int. Cl. F02M 25/08; F02D 41/00

(52) U.S. Cl. CPC F02M 25/0836; F02M 25/089; F02D 41/004

(57) ABSTRACT

An evaporated fuel treatment apparatus includes a canister for collecting vapor, a vapor passage for introducing the vapor from a fuel tank to the canister, a purge passage for introducing the vapor from the canister to an intake passage, an atmosphere passage for introducing atmospheric air into the canister, a purge pump provided in the atmosphere passage to pressure feed the vapor to the intake passage, a bypass atmosphere passage branching from the atmosphere passage downstream of the purge pump, an atmosphere check valve for opening/closing the atmosphere passage between a branch portion of the bypass passage and the purge pump, and an atmosphere opening/closing valve for opening/closing the bypass atmosphere passage. During operation of the purge pump, the atmosphere check valve is opened and the atmosphere opening/closing valve is closed. During non-operation of the purge pump, the atmosphere check valve is closed and the atmosphere opening/closing valve is opened.

### CROSS-REFERENCE TO RELATED APPLICATIONS

This application is based upon and claims the benefit of priority from the prior Japanese Patent Application No. 2019-004386 filed on Jan. 15, 2019, the entire contents of which are incorporated herein by reference.

### BACKGROUND

### Technical Field

This disclosure relates to an evaporated fuel treatment apparatus for treating evaporated fuel generated in a fuel tank.

### Related Art

Conventionally, as the above type of technique, there has been known an evaporated fuel treatment apparatus provided with for example a canister for collecting or trapping evaporated fuel generated in a fuel tank, a purge passage for guiding the evaporated fuel collected in the canister to an intake passage of an engine, and a purge pump for pressure feeding the evaporated fuel collected in the canister to the purge passage. The evaporated fuel treatment apparatus equipped with a purge pump is also used in a hybrid vehicle and the like in which the treatment time for vapor is apt to be shortened, and a vehicle equipped with an engine with a supercharger in which the negative pressure generated in an intake passage is apt to become low. Herein, in such a configuration that the pressure-fed vapor by the purge pump passes through the inside of the pump, a structure for explosion-proof measures or the like is required for the purge pump. Further, during non-operation of the purge pump, the purge pump itself becomes a flow resistance to the vapor.

Therefore, the apparatus described in Japanese Patent No. 6319036 is provided with an ejector in the purge passage. To this ejector, pressurized air is supplied from the purge pump, thereby generating a negative pressure in the ejector. This negative pressure causes vapor to be sucked from the canister and purged to the intake passage. This prevents the vapor from passing through the purge pump, thus eliminating the need for explosion-proof measures for the purge pump.

In addition, the apparatus described in U.S. Pat. No. 9,587,595 is provided with a purge pump in an atmosphere passage connected to an air inlet port of a canister, a bypass passage for bypassing the purge pump, and an opening/closing valve for opening and closing the bypass passage. This configuration prevents the purge pump itself from becoming a flow resistance to the vapor and opens the opening/closing valve to open the bypass passage during refueling of the fuel tank, thereby improving the ability of refueling of the fuel tank.

### SUMMARY

### Technical Problem

However, in the apparatus described in Japanese Patent No. 6319036, the vapor is sucked through the ejector and then purged to the intake passage. Thus, the purge efficiency is low and the purge response during startup of the purge pump is not good. Further, in the apparatus described in U.S. Pat. No. 9,587,595, the vapor may flow inside the purge pump when the bypass passage is opened. In view of such a possibility, the purge pump needs to take an explosion-proof measure. For this purpose, for example, it is necessary to use an expensive brushless motor for the purge pump.

The present disclosure has been made in view of the above-mentioned circumstances, and has an object to provide an evaporated fuel treatment apparatus configured to eliminate the need for explosion-proof measures for a purge pump, and to improve purge efficiency and purge response by means of a purge pump.

### Means of Solving the Problem

To achieve the above purpose, one aspect of the present disclosure provides an evaporated fuel treatment apparatus comprising: a canister configured to collect evaporated fuel which is generated in a fuel tank; an evaporated fuel passage configured to introduce the evaporated fuel from the fuel tank to the canister; a purge passage configured to introduce and purge the evaporated fuel collected in the canister to an intake passage of an engine; an atmosphere passage configured to introduce atmospheric air to the canister; a purge pump provided in the atmosphere passage and configured to supply pressurized air to the canister to pressure feed the evaporated fuel collected in the canister to the intake passage through the purge passage; a bypass atmosphere passage branching from the atmosphere passage downstream of the purge pump and communicating with atmosphere; a first opening/closing unit configured to open and close the atmosphere passage located between a branch portion of the bypass atmosphere passage branching from the atmosphere passage and the purge pump; and a second opening/closing unit configured to open and close the bypass atmosphere passage, the first opening/closing unit being opened and the second opening/closing unit being closed during operation of the purge pump, and the first opening/closing unit being closed and the second opening/closing unit being opened during non-operation of the purge pump.

According to the present disclosure, it is possible to eliminate the need for explosion-proof measures and improve the purge efficiency and the purge response by means of the purge pump.

### BRIEF DESCRIPTION OF THE DRAWING

FIG. 1 is a schematic diagram showing an engine system including an evaporated fuel treatment apparatus in a first embodiment;

FIG. 2 is a graph showing behaviors of pressure of pressurized air supplied to a canister in the first embodiment;

FIG. 3 is a schematic diagram showing an engine system including an evaporated fuel treatment apparatus in a second embodiment;

FIG. 4 is a schematic diagram showing an engine system including an evaporated fuel treatment apparatus in a third embodiment; and

FIG. 5 is a schematic diagram showing an engine system including an evaporated fuel treatment apparatus in a fourth embodiment.

### DETAILED DESCRIPTION OF THE EXEMPLARY EMBODIMENTS

### First Embodiment

Hereinafter, a first embodiment which embodies an evaporated fuel treatment apparatus will be described in detail with reference to the accompanying drawings.

### [Overview of Engine System]

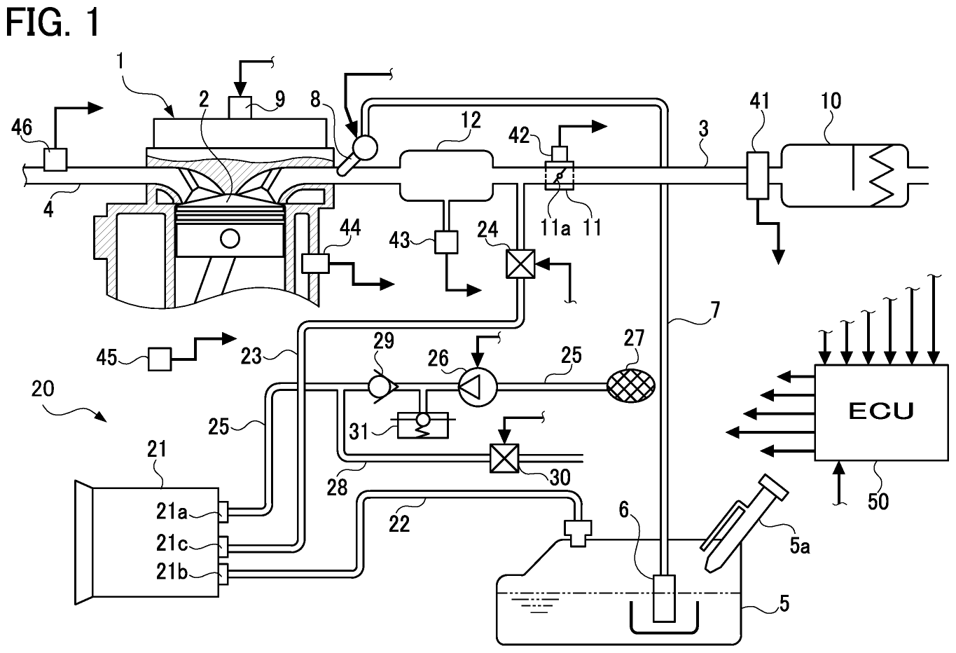

FIG. 1 is a schematic diagram showing an engine system including an evaporated fuel treatment apparatus 20 mounted on a vehicle. This vehicle may be a conventional gasoline engine vehicle or a hybrid vehicle. An engine 1 includes an intake passage 3 for drawing air and others into a combustion chamber 2, and an exhaust passage 4 for discharging exhaust gas from the combustion chamber 2. The combustion chamber 2 will be supplied with fuel stored in a fuel tank 5. That is, the fuel in the fuel tank 5 is ejected into a fuel passage 7 by a fuel pump 6 built in the fuel tank 5, and then pressure fed to an injector 8 provided in an intake port of the engine 1. The pressure-fed fuel is injected from the injector 8 and introduced into the combustion chamber 2 together with air flowing through the intake passage 3 to form a combustible air-fuel mixture, which is used for combustion. The engine 1 is provided with an ignition device 9 for igniting the combustible mixture.

In the intake passage 3, there are provided an air cleaner 10, a throttle device 11, and a surge tank 12 in this order from the inlet side of the intake passage 3 toward the engine 1. The throttle device 11 includes a throttle valve 11a and is configured to open and close to thereby adjust the flow rate of the intake air flowing through the intake passage 3. The throttle valve 11a is opened and closed in conjunction with the operation of an accelerator pedal (not shown) pressed by a driver. The surge tank 12 is operative to smooth the intake pulsation in the intake passage 3.

### [Configuration of Evaporated Fuel Treatment Apparatus]

In FIG. 1, the evaporated fuel treatment apparatus 20 of this embodiment is configured to process, or treat, the evaporated fuel generated in the fuel tank 5 without discharging the evaporated fuel into the atmosphere. This apparatus 20 includes a canister 21 configured to collect or trap vapor (i.e., evaporated fuel) which is generated in the fuel tank 5, an evaporated fuel passage 22 (a vapor passage) configured to introduce the vapor from the fuel tank 5 to the canister 21, a purge passage 23 configured to introduce and purge the vapor collected in the canister 21 to the intake passage 3 of the engine 1, a purge valve 24 provided in the purge passage 23 and configured to open and close under a duty control for adjusting a flow rate of the vapor flowing through the purge passage 23, an atmosphere passage 25 configured to introduce atmospheric air into the canister 21, and a purge pump 26 provided in the atmosphere passage 25 and configured to supply pressurized air to the canister 21.

The canister 21 contains an adsorbent such as activated carbon. The canister 21 includes an air inlet port 21a for introducing atmospheric air into the canister 21, an inlet port 21b for introducing vapor into the canister 21, and an outlet port 21c for discharging vapor out of the canister 21. The inside of the canister 21 communicates with the atmosphere through an atmosphere passage 25. Specifically, the atmosphere passage 25 extending from the air inlet port 21a communicates with the atmosphere. An air filter 27 for collecting dust and the like in the air is provided at a distal end of the atmosphere passage 25. A distal end of the vapor passage 22 extending from the inlet port 21b of the canister 21 communicates with the inside of the fuel tank 5. A distal end of the purge passage 23 extending from the outlet port 21c of the canister 21 communicates with the intake passage 3 between the throttle device 11 and the surge tank 12.

In this embodiment, the purge valve 24 is configured to open and close variably by an electrically operated valve. The duty control of the purge valve 24 is a control in which the valve opening and the valve closing are switched at a predetermined duty ratio and a predetermined drive cycle. In contrast, the purge pump 26 is configured to change_an ejection amount in order to pressure feed the vapor from the canister 21 to the purge passage 23. As the purge pump 26, for example, a turbine pump using an inexpensive and highly responsive brushed motor can be employed.

The evaporated fuel treatment apparatus 20 in the present embodiment is configured to introduce the vapor generated in the fuel tank 5 into the canister 21 via the vapor passage 22, and collect the vapor temporarily in the canister 21. During operation of the engine 1, the throttle device 11, i.e., the throttle valve 11a, is opened, the purge pump 26 is operated, and the purge valve 24 is controlled. This allows the vapor collected in the canister 21 to be purged from the canister 21 and into the intake passage 3 through the purge passage 23.

The evaporated fuel treatment apparatus 20 further includes a bypass atmosphere passage 28 branching from the atmosphere passage 25 downstream of the purge pump 26 and communicating with the atmosphere, an atmosphere check valve 29 configured to open and close the atmosphere passage 25 located between a branch portion or point of the bypass atmosphere passage 28 branching from the atmosphere passage 25 and the purge pump 26, an atmosphere opening/closing valve 30 configured to open and close the bypass atmosphere passage 28, and a pressure regulator 31 configured to regulate the pressure in the atmosphere passage 25 downstream of the purge pump 26.

In the present embodiment, the atmosphere check valve 29 is configured to allow atmospheric air to flow from the purge pump 26 to the canister 21, but block gas from flowing from the canister 21 to the purge pump 26. This atmosphere check valve 29 corresponds to one example of a first opening/closing unit in the present disclosure.

The atmosphere opening/closing valve 30 is constituted of an electrically operated opening/closing valve which is opened during refueling of the fuel tank 5. This atmosphere opening/closing valve 30 is a normally opened valve which is controlled by an ECU 50 to be described later to close when the purge pump 26 is operated, i.e., during operation of the purge pump 26, and open when the purge pump 26 is stopped, i.e., during non-operation of the purge pump 26. The atmosphere opening/closing valve 30 and the ECU50 correspond to one example of a second opening/closing unit in the present disclosure.

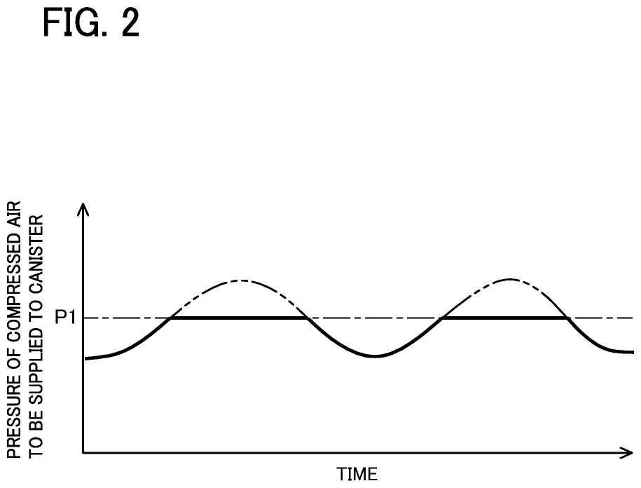

Further, the pressure regulator 31 is configured to adjust the pressure of the atmospheric air in the atmosphere passage 25 downstream of the purge pump 26 to a predetermined value P1. This pressure regulator 31 corresponds to one example of a pressure regulating unit in the present disclosure. When the pressure of the atmospheric air in the atmosphere passage 25 located between the purge pump 26 and the atmosphere check valve 29 exceeds the predetermined value P1 as indicated by a two-dot chain line in FIG. 2, the pressure regulator 31 discharges excess air to adjust the pressure to the predetermined value P1 as indicated by a thick line in FIG. 2. FIG. 2 is a graph showing the behavior of the pressure of the pressurized air to be supplied to the canister 21.

### [Electrical Configuration of Engine System]

In the first embodiment, various sensors 41 to 46 are provided to detect the operating state of the engine 1. The air flow meter 41 provided near the air cleaner 10 detects the amount of air sucked into the intake passage 3 as an intake air amount, and outputs an electric signal corresponding to a detected value. The throttle sensor 42 provided to the throttle device 11 is configured to detect the opening degree of the throttle valve 11a as a throttle opening degree, and outputs an electric signal corresponding to a detected value. The intake pressure sensor 43 provided to the surge tank 12 is configured to detect the pressure in the surge tank 12 as an intake pressure, and outputs an electric signal corresponding to a detected value. The water temperature sensor 44 provided to the engine 1 is configured to detect the temperature of the cooling water flowing inside the engine 1 as a cooling water temperature, and outputs an electric signal corresponding to a detected value. The rotational speed sensor 45 provided to the engine 1 is configured to detect the rotational angular velocity of a crankshaft (not shown) of the engine 1 as the number of rotations of an engine, and outputs an electric signal corresponding to a detected value. An air-fuel ratio sensor (an A/F sensor) 46 provided to the exhaust passage 4 is configured to detect the concentration of hydrocarbons in exhaust gas, and outputs an electric signal corresponding to a detected value.

In the present embodiment, the electronic control unit (ECU) 50 configured to perform various controls receives various signals output from the aforementioned various sensors 41 to 46 and others. Based on those received signals, the ECU50 controls the injector 8, the ignition device 9, the purge valve 24, the purge pump 26, and the atmosphere opening/closing valve 30 to perform fuel injection control, ignition timing control, and purge control.

Herein, the fuel injection control is to control the injector(s) 8 according to the operating state of the engine 1 to thereby adjust the amount of fuel to be injected and the timing for injecting the fuel. The ignition timing control is to control the ignition device(s) 9 according to the operating state of the engine 1 to thereby adjust the timing for igniting the combustible air-fuel mixture. The purge control is to control the purge valve 24 and the purge pump 26 mainly according to the operating state of the engine 1 to thereby adjust the flow rate of the vapor to be purged from the canister 21 to the intake passage 3.

In the present embodiment, the ECU50 is configured to operate the purge pump 26, duty control the purge valve 24, and close the atmosphere opening/closing valve 30 during execution of the purge control to purge the vapor from the canister 21 to the intake passage 3. The ECU50 is provided with well-known structures including a central processing unit (CPU), a read-only memory (ROM), a random-access memory (RAM), and a back-up RAM. The ROM stores in advance predetermined control programs relating to the above-described various controls. The ECU (CPU) 50 is configured to execute the above-described various controls in accordance with those control programs.

### [Operations and Effects of Evaporated Fuel Treatment Apparatus]

According to the evaporated fuel treatment apparatus 20 of the present embodiment described above, the purge pump 26 for pressure feeding the vapor from the canister 21 to the intake passage 3 via the purge passage 23 is provided in the atmosphere passage 25. During operation of the purge pump 26, the atmosphere check valve 29 provided in the atmosphere passage 25 is opened and the atmosphere opening/closing valve 30 provided in the bypass atmosphere passage 28 is closed. Therefore, when the vapor is to be purged to the intake passage 3, the pressurized air is supplied to the canister 21, but the vapor does not flow to the purge pump 26. In contrast, during non-operation of the purge pump 26, the atmosphere check valve 29 is closed and the atmosphere opening/closing valve 30 is opened. Therefore, even if the vapor flows out from the canister 21 to the atmosphere passage 25 while the vapor is not purged to the intake passage 3, the vapor is allowed to be discharged to the atmosphere through the bypass atmosphere passage 28 without flowing to the purge pump 26. This can eliminate the need for the explosion-proof measure for the purge pump 26 and thus enhance the purge efficiency and the purge response by the purge pump 26.

In the present embodiment, since the explosion-proof measure for the purge pump 26 does not need to be provided, a pump using a brushed motor can be used as the purge pump 26. Such a pump using a brushed motor needs no circuit and thus can be configured at low cost, and further does not need to detect a rotor position, so that the pump can achieve high responsiveness. Further, since the bypass atmosphere passage 28 is branched from the atmosphere passage 25, when the fuel tank 5 is refueled during non-operation of the purge pump 26, the vapor flowing out from the canister 21 to the atmosphere passage 25 will escape to the atmosphere through the bypass atmosphere passage 28. This can reduce the pressure loss during refueling and form the activated carbon located on the atmosphere side of the canister 21, i.e., near the air inlet port 21a, into multiple layers.

According to the configuration of the present embodiment, the atmospheric air pressure in the atmosphere passage 25 downstream of the purge pump 26 is adjusted to a predetermined value P1 by the pressure regulator 31, as shown in FIG. 2. Thus, even if the ejection pressure of the purge pump 26 fluctuates unstably, the fluctuation of the pressurized air supplied from the atmosphere passage 25 to the canister 21 is reduced. For example, when the purge pump 26 constituted of a brushed motor is directly connected to and driven by a battery, the number of revolutions of the motor fluctuates unstably, and the pressure of the atmosphere at a position downstream of the purge pump 26 exceeds the predetermined value P1, the pressure regulator 31 discharges excess air, thus reducing the pressure of the pressurized air to be supplied to the canister 21 to the predetermined value P1. Consequently, the flow rate of the vapor to be purged from the canister 21 to the intake passage 3 can be stabilized. In this case, since the vapor does not flow into the pressure regulator 31, there is no problem in discharging excess air from the pressure regulator 31 to the atmosphere.

### Second Embodiment

Next, a second embodiment which embodies the evaporated fuel treatment apparatus will be described in detail with reference to the accompanying drawings.

In each of the embodiments described below, parts or components equivalent to those of the first embodiment are assigned the same reference numerals and their details will be omitted. Thus, the following embodiments will be described with a focus on differences from the first embodiment.

### [Configuration of Evaporated Fuel Treatment Apparatus]

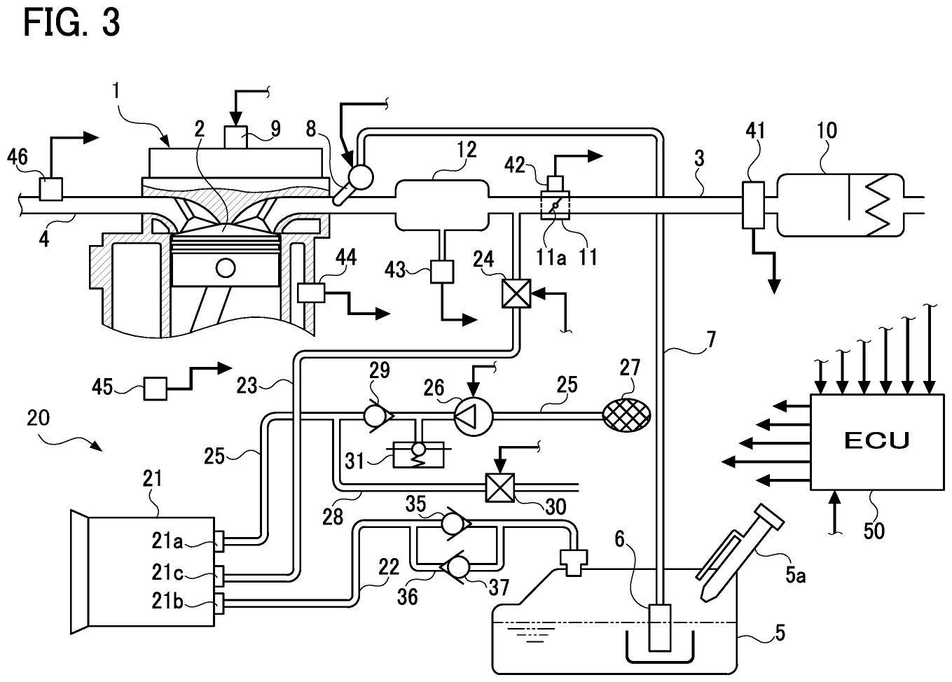

FIG. 3 is a schematic diagram showing an engine system including the evaporated fuel treatment apparatus 20 in the second embodiment. This embodiment differs from the first embodiment in the configuration related to the vapor passage 22. Specifically, as shown in FIG. 3, a first evaporated fuel check valve (i.e., a first vapor check valve) 35 is provided in the vapor passage 22. In addition, a bypass evaporated fuel passage (i.e., a bypass vapor passage) 36 is provided to the vapor passage 22 to detour around the first vapor check valve 35. In this bypass evaporated fuel passage 36, there is provided a second evaporated fuel check valve (i.e., a second vapor check valve) 37.

In the present embodiment, the first vapor check valve 35 is configured to allow vapor to flow from the fuel tank 5 to the canister 21, but block gas from flowing from the canister 21 to the fuel tank 5. The first vapor check valve 35 is also configured to close when the pressure in the fuel tank 5 is lower than the pressure acting on the canister 21 from the atmosphere passage 25 and open when the pressure in the fuel tank 5 is higher than the pressure acting on the canister 21 from the atmosphere passage 25. The first vapor check valve 35 is also configured to open when the pressure in the fuel tank 5 rises during non-operation of the purge pump 26.

In the present embodiment, the second vapor check valve 37 is configured to block evaporated fuel from flowing from the fuel tank 5 to the canister 21 and allow gas to flow from the canister 21 to the fuel tank 5. The second vapor check valve 37 is also configured to open when the pressure in the fuel tank 5 becomes a negative pressure equal to or lower than a predetermined value and close when the pressure in the fuel tank 5 becomes higher than the pressure acting on the canister 21 from the atmosphere passage 25.

In the present embodiment, when the internal temperature of the fuel tank 5 changes from high to low, the fuel tank 5 is hermetically closed by the first vapor check valve 35, so that the inner pressure of the fuel tank 5 becomes a negative pressure. When the pressure in the fuel tank 5 becomes a negative pressure equal to or lower than a predetermined value, the second vapor check valve 37 is opened. However, the opening pressure of the second vapor check valve 37 is set higher than the ejection pressure of the purge pump 26 so that the inside of the fuel tank 5 is not pressurized by the ejection pressure of the purge pump 26.

### [Operations and Effects of Evaporated Fuel Treatment Apparatus]

According to the evaporated fuel treatment apparatus 20 of the present embodiment described above, the following operations and effects are achieved in addition to the operations and effects in the first embodiment. Specifically, since the first vapor check valve 35 provided in the vapor passage 22 is closed when the pressure in the fuel tank 5 is lower than the pressure acting on the canister 21 from the atmosphere passage 25, i.e., the ejection pressure of the purge pump 26, the flow of gas from the canister 21 to the fuel tank 5 is blocked. Thus, the pressure in the fuel tank 5 does not become excessively positive. This can prevent the fuel tank 5 from being damaged by such an excessive positive pressure in the fuel tank 5. In contrast, since the first vapor check valve 35 is opened when the pressure in the fuel tank 5 is higher than the ejection pressure of the purge pump 26, vapor is allowed to flow from the fuel tank 5 to the canister 21 even while the purge pump 26 is operating. Thus, even during operation of the purge pump 26, the vapor can be collected in the canister 21.

On the other hand, the second vapor check valve 37 provided in the bypass vapor passage 36 is opened when the pressure in the fuel tank 5 becomes a negative pressure equal to or lower than the predetermined value. Thus, the pressure in the fuel tank 5 does not become excessively negative. This can prevent the fuel tank 5 from being damaged due to excessive negative pressure in the fuel tank 5. In contrast, the second vapor check valve 37 is closed when the pressure in the fuel tank 5 becomes higher than the ejection pressure of the purge pump 26. Thus, an excessive flow of vapor from the fuel tank 5 to the canister 21 is blocked. This can prevent excessive collection of vapor in the canister 21.

### Third Embodiment

Next, a third embodiment which embodies the evaporated fuel treatment apparatus will be described in detail with reference to the accompanying drawings.

### [Configuration of Evaporated Fuel Treatment Apparatus]

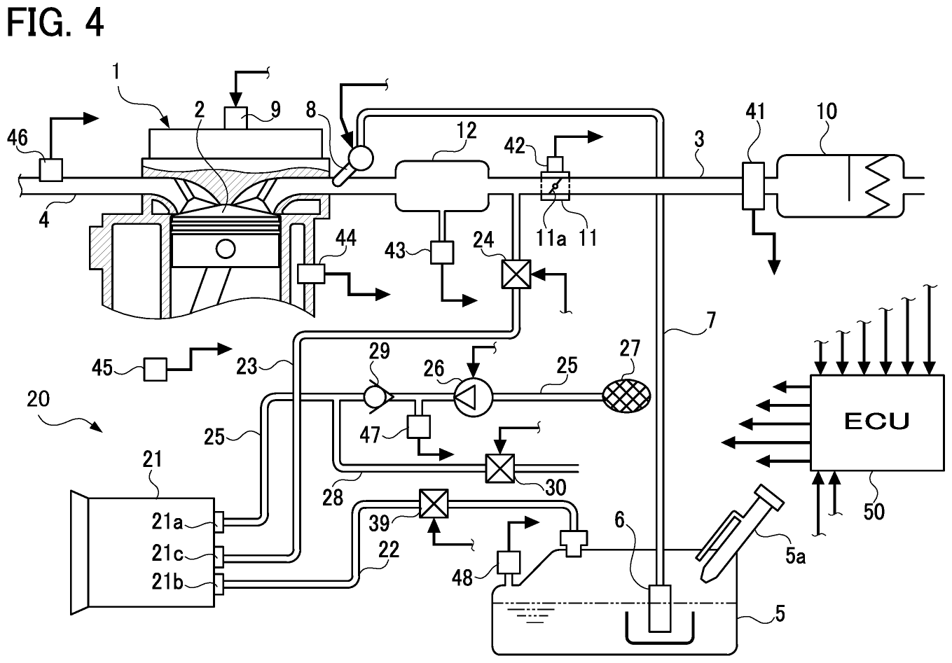

FIG. 4 is a schematic diagram showing an engine system including the evaporated fuel treatment apparatus 20 in the third embodiment. This embodiment differs from the second embodiment in the configuration related to the atmosphere passage 25 and the vapor passage 22. Specifically, as shown in FIG. 4, instead of the pressure regulator 31, a pump pressure sensor 47 is provided to the atmosphere passage 25 at a portion between the purge pump 26 and the atmosphere check valve 29. This pump pressure sensor 47 is configured to detect the pressure at that portion (i.e., the ejection pressure of the purge pump 26 (the pump ejection pressure), that is, the pressure of the pressurized air to be supplied to the canister 21). Furthermore, instead of the first vapor check valve 35, the second vapor check valve 37, and the bypass vapor passage 36, an electrically-operated evaporated fuel valve (i.e., a vapor valve) 39 is provided in the vapor passage 22. The fuel tank 5 is provided with a tank pressure sensor 48 configured to detect the pressure in the fuel tank 5, that is, the tank inner pressure. The ECU50 is configured to control the purge valve 24 and the vapor valve 39 based on the values detected by the pump pressure sensor 47 and the tank pressure sensor 48. Herein, the vapor valve 39 may be an opening/closing valve which can simply open and close or may be a control valve configured to change its opening degree to regulate a flow rate. The pump pressure sensor 47 may be provided to the atmosphere passage 25 at a portion between the atmosphere check valve 29 and the canister 21. The pump pressure sensor 47 corresponds to one example of a first pressure detecting unit in the present disclosure. The tank pressure sensor 48 corresponds to one example of a second pressure detecting unit in the present disclosure.

In the present embodiment, the ECU50 is configured to control the purge valve 24 so that the pump ejection pressure detected by the pump pressure sensor 47 becomes a predetermined value. The ECU50 is also configured to open the vapor valve 39 from a closed state under one of the following conditions (i) to (iii): (i) when the tank internal pressure detected by the tank pressure sensor 48 becomes a positive pressure equal to or higher than a predetermined value, (ii) when he tank internal pressure detected by the tank pressure sensor 48 becomes a negative pressure equal to or lower than the predetermined value, or (iii) when the detected tank internal pressure becomes higher than the detected pump ejection pressure. The ECU50 corresponds to one example of a first controller and a second controller in the present disclosure.

### [Operation and Effects of Evaporated Fuel Treatment Apparatus]

According to the evaporated fuel treatment apparatus 20 of the present embodiment described above, the following operations and effects are achieved in addition to the operations and effects in the second embodiment. Specifically, the purge valve 24 is controlled by the ECU 50 so that the pressure of the pressurized air to be supplied from the purge pump 26 to the canister 21 is adjusted to a predetermined value. Thus, even when the ejection pressure of the purge pump 26 is not stabilized, the pressure of the pressurized air to be supplied to the canister 21 is stabilized. This can stabilize the flow rate of the vapor to be purged from the canister 21 to the intake passage 3.

According to the configuration of the present embodiment, the vapor valve 39 is controlled by the ECU50 based on the detected pump ejection pressure and the detected tank inner pressure. In the present embodiment, since the vapor valve 39 is opened when the detected tank inner pressure becomes a positive pressure equal to or higher than a predetermined value, the pressure in the fuel tank 5 does not become an excessive positive pressure. This can prevent the fuel tank 5 from being damaged by such excessive pressurization. Further, since the vapor valve 39 is opened when the detected tank inner pressure becomes a negative pressure equal to or lower than the predetermined value, the pressure in the fuel tank 5 does not become an excessive negative pressure. This can prevent the fuel tank 5 from being damaged by such a negative pressure. Furthermore, since the vapor valve 39 is opened when the detected tank inner pressure becomes higher than the detected pump ejection pressure, vapor is allowed to flow from the fuel tank 5 to the canister 21 even while the purge pump 26 is operating. Thus, even during operation of the purge pump 26, the vapor can be collected in the canister 21.

### Fourth Embodiment

Next, a fourth embodiment which embodies the evaporated fuel treatment apparatus will be described in detail with reference to the accompanying drawings.

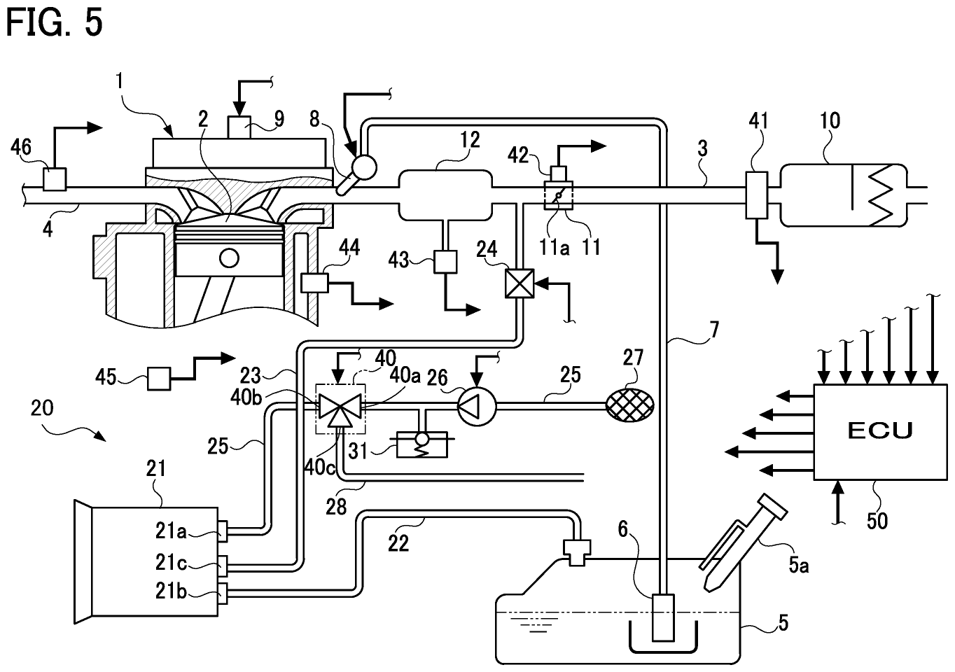

FIG. 5 is a schematic diagram showing an engine system including the evaporated fuel treatment apparatus 20 in the fourth embodiment. This embodiment differs from the first embodiment in the configuration related to the atmosphere passage 25 and the bypass atmosphere passage 28. Specifically, in the present embodiment, as shown in FIG. 5, instead of the atmosphere check valve 29 and the atmosphere opening/closing valve 30, an atmosphere three-way valve 40 is provided at a branch portion between the atmosphere passage 25 and the bypass atmosphere passage 28. Herein, the atmosphere three-way valve 40 includes an inlet 40a communicating with the upstream side of the atmosphere passage 25, a first outlet 40b communicating with the downstream side of the atmosphere passage 25, and a second outlet 40c communicating with the bypass atmosphere passage 28.

The ECU50 is configured to control (turn on/off) the atmosphere three-way valve 40 based on controlling (turning on/off) the purge pump 26. Specifically, when the purge pump 26 is operated (when it is turned on), the atmosphere three-way valve 40 is turned “on”, whereby switching to a first communication state in which the inlet 40a and the first outlet 40b communicate with each other, and the inlet 40a and the first outlet 40b are cut off from communication with the second outlet 40c. Specifically, the three-way valve 40 is configured to switch to the first communication state to allow the communication between the canister 21 and the purge pump 26, but cut off the communication of the canister 21 and the purge pump 26 with the bypass atmosphere passage 28. In contrast, when the purge pump 26 is stopped (when the purge pump 26 is turned off), the atmosphere three-way valve 40 is turned “off”, whereby switching to a second communication state in which the first outlet 40b and the second outlet 40c communicate with each other, and the first outlet 40b and the second outlet 40c are cut off from communication with the inlet 40a. Specifically, the three-way valve 40 is configured to switch to the second communication state to cut off the communication between the canister 21 and the purge pump 26 and allow the communication between the canister 21 and the bypass atmosphere passage 28. The atmosphere three-way valve 40 and the ECU50 correspond to one example of a first opening/closing unit and a second opening/closing unit in the present disclosure.

### [Operations and Effects of Evaporated Fuel Treatment Apparatus]

According to the evaporated fuel treatment apparatus 20 of the present embodiment described above, the purge pump 26 is provided in the atmosphere passage 25 to pressure feed the vapor from the canister 21 to the intake passage 3 through the purge passage 23. During operation of the purge pump 26, the atmosphere three-way valve 40 is switched to the first communication state, so that the canister 21 and the purge pump 26 come into communication with each other, whereas the canister 21 and the bypass atmosphere passage 28 are cut off from communicating with each other. Thus, when the vapor is to be purged to the intake passage 3, the pressurized air is supplied to the canister 21 and the vapor does not flow to the purge pump 26. In contrast, when the purge pump 26 is stopped, the atmosphere three-way valve 40 is switched to the second communication state, thus cutting off the communication between the canister 21 and the purge pump 26 and allowing the communication between the canister 21 and the bypass atmosphere passage 28. Therefore, even if the vapor flows out from the canister 21 to the atmosphere passage 25 while the vapor is not to be purged to the intake passage 3, the vapor is discharged to the atmosphere through the bypass atmosphere passage 28 without flowing to the purge pump 26. This can eliminate the need for the explosion-proof measure of the purge pump 26 and thus enhance the purge efficiency and the purge response by the purge pump 26. Other operations and effects of the present embodiment are the same as those of the first embodiment.

The foregoing embodiments are mere examples and give no limitation to the present disclosure. The present disclosure may be embodied in other specific forms without departing from the essential characteristics thereof.

(1) In the first to third embodiments, the first opening/closing unit in the present disclosure is embodied by the atmosphere check valve 29 configured to open during operation of the purge pump 26 and close during non-operation of the purge pump 26. On the other hand, the first opening/closing unit may also be embodied by an opening/closing valve configured to open during operation of a purge pump and close during non-operation of the purge pump.

(2) In the fourth embodiment, the atmosphere three-way valve 40 is provided at the branch portion between the atmosphere passage 25 and the bypass atmosphere passage 28, instead of the atmosphere check valve 29 and the atmosphere opening/closing valve 30 in the first embodiment. In the second and third embodiments, similarly, instead of the atmosphere check valve 29 and the atmosphere opening/closing valve 30, an atmosphere three-way valve may be provided at the branch portion between the atmosphere passage 25 and the bypass atmosphere passage 28. Also in any cases, the communication relationship among the atmosphere passage 25, the bypass atmosphere passage 28, the canister 21, and the purge pump 26 can provide the same operations and effect as those in the fourth embodiment.

### INDUSTRIAL APPLICABILITY

The present disclosure is applicable to a regular engine system provided with an evaporated fuel treatment apparatus or an engine system for a hybrid vehicle.

### REFERENCE SIGNS LIST

1 Engine
3 Intake passage
5 Fuel tank
20 Evaporated fuel treatment apparatus
21 Canister
22 Vapor passage (Evaporated fuel passage)
23 Purge passage
24 Purge valve
25 Atmosphere passage
26 Purge pump
28 Bypass atmosphere passage
29 Atmosphere check valve (First opening/closing unit)
30 Atmosphere opening/closing valve (Second opening/closing unit)
31 Pressure regulator (Pressure regulating unit)
35 First vapor check valve (First evaporated fuel check valve)
36 Bypass vapor passage (Bypass evaporated fuel passage)
37 Second vapor check valve (Second evaporated fuel check valve)
39 Vapor valve (Evaporated fuel valve)
40 Atmosphere three-way valve
47 Pump pressure sensor (First pressure detecting unit)
48 Tank pressure sensor (Second pressure detecting unit)
50 ECU (First opening/closing unit, Second opening/closing unit, First controller, Second controller)

What is claimed is:

1. An evaporated fuel treatment apparatus comprising:
a canister configured to collect evaporated fuel which is generated in a fuel tank;
an evaporated fuel passage configured to introduce the evaporated fuel from the fuel tank to the canister;
a purge passage configured to introduce and purge the evaporated fuel collected in the canister to an intake passage of an engine;
an atmosphere passage configured to introduce atmospheric air to the canister;
a purge pump provided in the atmosphere passage and configured to supply pressurized air to the canister to pressure feed the evaporated fuel collected in the canister to the intake passage through the purge passage;
a bypass atmosphere passage branching from the atmosphere passage downstream of the purge pump and communicating with atmosphere;
a first opening/closing unit configured to open and close the atmosphere passage located between a branch portion of the bypass atmosphere passage branching from the atmosphere passage and the purge pump; and
a second opening/closing unit configured to open and close the bypass atmosphere passage,
the first opening/closing unit being opened and the second opening/closing unit being closed during operation of the purge pump, and
the first opening/closing unit being closed and the second opening/closing unit being opened during non-operation of the purge pump.

2. The evaporated fuel treatment apparatus according to claim 1, wherein
the first opening/closing unit is an atmosphere check valve configured to allow the atmospheric air to flow from the purge pump to the canister, but block the atmospheric air from flowing from the canister to the purge pump, and
the second opening/closing unit includes an atmosphere opening/closing valve configured to close during operation of the purge pump and open during non-operation of the purge pump.

3. The evaporated fuel treatment apparatus according to claim 1, wherein
the first opening/closing unit and the second opening/closing unit include an atmosphere three-way valve provided at the branch portion of the bypass atmosphere passage branching from the atmosphere passage, and
the atmosphere three-way valve is configured such that, during operation of the purge pump, the atmosphere three-way valve switches to a first communication state to allow communication between the canister and the purge pump, but cut off communication between the canister and the bypass atmosphere passage and, during non-operation of the purge pump, the atmosphere three-way valve switches to a second communication state to cut off communication between the canister and the purge pump, but allow communication between the canister and the bypass atmosphere passage.

4. The evaporated fuel treatment apparatus according to claim 1 further comprising a pressure regulating unit configured to adjust pressure in the atmosphere passage downstream of the purge pump to a predetermined value.

5. The evaporated fuel treatment apparatus according to claim 2 further comprising a pressure regulating unit configured to adjust pressure in the atmosphere passage downstream of the purge pump to a predetermined value.

6. The evaporated fuel treatment apparatus according to claim 3 further comprising a pressure regulating unit configured to adjust pressure in the atmosphere passage downstream of the purge pump to a predetermined value.

7. The evaporated fuel treatment apparatus according to claim 1 further comprising:
a purge valve configured to adjust a flow rate of the evaporated fuel flowing through the purge passage;
a first pressure detecting unit configured to detect the pressure in the atmosphere passage downstream of the purge pump; and
a first controller configured to control the purge valve so that the detected pressure in the atmosphere passage becomes a predetermined value.

8. The evaporated fuel treatment apparatus according to claim 2 further comprising:
a purge valve configured to adjust a flow rate of the evaporated fuel flowing through the purge passage;
a first pressure detecting unit configured to detect the pressure in the atmosphere passage downstream of the purge pump; and
a first controller configured to control the purge valve so that the detected pressure in the atmosphere passage becomes a predetermined value.

9. The evaporated fuel treatment apparatus according to claim 3 further comprising:
a purge valve configured to adjust a flow rate of the evaporated fuel flowing through the purge passage;
a first pressure detecting unit configured to detect the pressure in the atmosphere passage downstream of the purge pump; and
a first controller configured to control the purge valve so that the detected pressure in the atmosphere passage becomes a predetermined value.

10. The evaporated fuel treatment apparatus according to claim 1 further comprising a first evaporated fuel check valve provided in the evaporated fuel passage and configured to allow the evaporated fuel to flow from the fuel tank toward the canister, but block gas from flowing from the canister toward the fuel tank,
the first evaporated fuel check valve being configured to close when pressure in the fuel tank is lower than pressure that acts on the canister from the atmosphere passage, and open when the pressure in the fuel tank is higher than the pressure that acts on the canister from the atmosphere passage.

11. The evaporated fuel treatment apparatus according to claim 10 further comprising:
a bypass evaporated fuel passage provided to the evaporated fuel passage to detour around the first evaporated fuel check valve; and
a second evaporated fuel check valve provided in the bypass evaporated fuel passage and configured to block the evaporated fuel from flowing from the fuel tank toward the canister, but allow the gas to flow from the canister toward the fuel tank,
the second evaporated fuel check valve being configured to open when pressure in the fuel tank is a negative pressure equal to or lower than the predetermined value and close when the pressure in the fuel tank is higher than the pressure that acts on the canister from the atmosphere passage.

12. The evaporated fuel treatment apparatus according to claim 7 further comprising:
an evaporated fuel valve configured to open and close the evaporated fuel passage;
a second pressure detecting unit configured to detect the pressure in the fuel tank; and
a second controller configured to control the evaporated fuel valve based on the detected pressure in the atmosphere passage and the detected pressure in the fuel tank,
the second controller being configured to open the evaporated fuel valve from a valve closed state (i) when the detected pressure in the fuel tank is a positive pressure equal to or higher than the predetermined value, (ii) when the detected pressure in the fuel tank is a negative pressure equal to or lower than the predetermined value, or (iii) when the detected pressure in the fuel tank is higher than the detected pressure in the atmosphere passage.
